(19) United States
(12) Patent Application Publication
(10) Pub. No.: US 2026/0333274 A1
(43) Pub. Date: Oct. 22, 2026

(54) CELLULAR NETWORK CONNECTIVITY DEVICE PROCEDURES

(71) Applicant: TRUPHONE LIMITED, London (GB)

(72) Inventors: Scott MACKENZIE, London (GB); João Afonso Vieira CASAL, London (GB); Carlos Hugo Baptista MORGADO, London (GB); Victor Manuel Vieira PINTO, London (GB); Catarina Pires MOTA, London (GB)

(21) Appl. No.: 19/105,530

(22) PCT Filed: Aug. 21, 2023
(86) PCT No.: PCT/EP2023/072918

§ 371 Date: Feb. 21, 2025

(30) Foreign Application Priority Data
Aug. 22, 2022 (GB) 2212205.5

(51) Int. Cl. H04W 60/04; H04W 8/26; H04W 24/08

(52) U.S. Cl. CPC H04W 60/04; H04W 8/26; H04W 24/08

(57) ABSTRACT

Some embodiments relate to a computer-implemented method for requesting to register a subscription device for service with one or more cellular network is provided. The method involves providing a profile comprising a plurality of IMSIs for registering a subscription device for service with one or more cellular network. A first registration request procedure is performed to request to register the subscription device for service with a cellular network. The first registration request procedure involves selecting a first IMSI, performing an attach request procedure. A connection test procedure, involving transmitting a connection test message to a test server is performed. A second registration request procedure is performed, wherein performing the second registration request procedure is triggered in dependence on receipt of a response to the connection test message. A subscription device, connection test server, and non-transitory computer readable storage medium are also provided.

### CROSS-REFERENCE TO RELATED APPLICATIONS

This application is a national phase filing under 35 C.F.R. § 371 of and claims priority to PCT Patent Application No. PCT/EP2023/072918, filed on Aug. 21, 2023, which claims the priority benefit under 35 U.S.C. § 119 of British Patent Application No. 2212205.5, filed on Aug. 22, 2022, the contents of each are hereby incorporated in its entirety by reference.

### TECHNICAL FIELD

The presently disclosed subject matter relates to telecommunications and in particular to a cellular network authentication method to obtain and/or manage cellular network connectivity.

### BACKGROUND

Generally, Internet of Things (IoT), Machine to Machine (M2M), and consumer devices are arranged to use a Universal Integrated Circuit Card (UICC). A UICC is a hardware device that typically implements a Subscriber Identification Module (SIM). A UICC may also implement other applications outside of the SIM including applications for managing contact lists, and access to multiple network types including GSM and UMTS. In recent implementations an embedded Universal Integrated Circuit Card (eUICC), also referred to as embedded Subscriber Identification Module (eSIM), an integrated Universal Integrated Circuit Card (iUICC), or a software-based SIM (soft SIM), may be provided in a host device.

These UICCs are used, with SIM applications, to provide authentication to a Mobile Network Operator (MNO) or to a Mobile Virtual Network Operator (MVNO) and enable the host device to access the services provided by said network. UICCs are implemented in the form of a small card that can be inserted and removed from the device. The eUICCs are generally implemented as small chips that are provided in devices in a non-removable way. The iUICCs are generally implemented in the form of a system-on-chip solution in which the UICC capabilities run on the device's native chipset. The soft SIMs typically include a collection of software applications and data that performs all the functionality of a SIM card but does not reside in any kind of secure data storage or use a secure processor and is, instead, stored in the memory and processor of the host device itself (i.e. there is no specific SIM hardware).

Within the present description, a secure module may be any of UICC, eUICC, iUICC, or soft SIM that can be included in IoT devices, M2M devices, or other devices.

In the cases of UICC, eUICC, iUICC, and soft SIMs, the authentication and access to services provided by a mobile network may be performed through by using a profile that includes information used to authenticate a subscriber to a cellular network. These profiles may be obtained through Remote SIM Provisioning (RSP), that is, the downloading, installing and enabling of an operational profile, also referred to as SIM profile, Over-The-Air (OTA).

The presence of secure modules such as UICCs, eUICCS, iUICCs or soft SIMs in IoT devices, M2M devices, and other devices is increasing, and it may be possible to provide connectivity to a device out of the box.

A multi-IMSI SIM is typically a SIM which enables profiles which include a plurality of International Mobile Subscriber Identifiers, IMSIs.

### SUMMARY

According to a first aspect of the present disclosure there is provided a computer-implemented method for requesting to register a subscription device for service with one or more cellular network, the computer-implemented method comprising: providing a profile comprising a plurality International Mobile Subscriber Identities, IMSIs, for registering the subscription device for service with one or more cellular network; performing a first registration request procedure to request to register the subscription device for service with a cellular network, the first registration request procedure comprising: selecting a first IMSI from the plurality of IMSIs; and performing an attach request procedure to attach to the cellular network using the first IMSI, performing a connection test procedure, the connection test procedure comprising: transmitting a connection test message to a test server; and performing a second registration request procedure to request to register the subscription device for service with a cellular network, the second registration request process comprising: selecting a second IMSI from the plurality of IMSIs; and performing an attach request procedure to attach to the cellular network using the second IMSI, wherein performing the second registration request procedure is triggered in dependence on receipt of a response to the connection test message.

According to a second aspect of the present disclosure there is provided a subscription device comprising at least one processor and at least one memory, the at least one memory comprising computer-executable instructions which, when executed by the at least one processor, cause the processor to perform a computer-implemented method according to the first aspect.

According to a third aspect of the present disclosure there is provided a non-transitory computer-readable storage medium comprising computer-executable instructions which, when executed by a processor, cause the processor to perform a computer-implemented method according to the first aspect.

According to a fourth aspect of the present disclosure there is provided a computer-implemented method for operating a connection test server, the computer implemented method comprising: obtaining a test message from a subscription device according to the second aspect, the message including an indication of the subscription device; and responding to the test message to confirm receipt of the test message.

According to a fifth aspect of the present disclosure there is provided a connection test server comprising: at least one processor; and at least one memory, the at least one memory comprising computer-executable instructions which, when executed by the at least one processor, cause the at least one processor to perform a method according to the fourth aspect.

### BRIEF DESCRIPTION OF THE DRAWINGS

FIG. 1 is a schematic diagram showing examples of two cellular networks and subscription devices;

FIG. 2 is a sequence diagram showing examples of device attach request procedures according;

FIG. 3 is a schematic diagram showing a subscription device 300 according to examples;

FIG. 4 is a flow chart showing a method for requesting to register a subscription device according to examples;

FIG. 5 is a flow chart showing a registration request procedure according to examples;

FIG. 6 is a flow chart showing a connection test procedure according to examples;

FIG. 7 is a schematic diagram showing cellular networks, subscription devices, and a test server according to examples;

FIG. 8 is a sequence diagram showing registration request procedures and connection test procedures according to examples;

FIG. 9 is a schematic diagram showing a test message according to examples;

FIG. 10 is schematic diagram showing a test server according to examples;

FIG. 11 is a flow chart showing a method performed by the test server according to examples;

FIG. 12 is a schematic diagram showing a non-transitory computer readable storage medium comprising instructions for performing the method according to the examples shown in FIGS. 4 to 6;

FIG. 13 is schematic diagram showing a non-transitory computer-readable storage medium comprising instructions for performing a method according to the examples shown in FIG. 11;

FIG. 14 is a schematic diagram showing an overview of a registration request procedure and method for managing registration requests from subscription devices according to examples;

FIG. 15 is a schematic diagram showing a computer system configured to perform the method for managing registration requests according to examples;

FIG. 16 is a flow chart showing a computer-implemented method performed by the computer system according to the examples illustrated in FIG. 15;

FIG. 17 is a schematic diagram showing the method of FIG. 16 according to examples;

FIG. 18 is a schematic diagram showing a non-transitory computer readable storage medium comprising instructions for performing the method according to the examples shown in FIGS. 15 to 17;

### DETAILED DESCRIPTION

Computing devices with cellular network connectivity capabilities, referred to herein as subscription devices, are generally able to obtain cellular network connectivity through procedures in which they request to attach to a cellular network using credentials. If the credentials are authenticated by the cellular network, then the subscription device may be registered for service and a communications session may be initiated. This process may also be referred to as requesting to register for service with a cellular network.

Subscription devices, such as a mobile smartphones, generally include a SIM application that is associated with a mobile network operator (MNO), or mobile virtual network operators (MVNO). The SIM application is typically implemented in at least one of a UICC, eUICCs, iUICCs, or soft-SIMS included in the subscription device. MNOs or MVNOs are also sometimes known as carrier service providers, mobile phone operators, or mobile network carriers. MNOs and MVNOs are organisations that provide wireless voice and data communication for their subscribed users. MNOs generally own and/or operate the wireless network infrastructure in a cellular network, the back-haul infrastructure, billing, customer care, provisioning computer systems, and other services used to provide wireless network connectivity to subscribers. MVNOs generally rent access to the cellular networks from MNOs. In the following description, where reference to a mobile network operator is made, it is to be appreciated that the related description is also relevant to mobile virtual network operators, unless explicitly stated otherwise.

Credentials used by a subscription device to attach to a cellular network include International Mobile Subscriber Identifiers (IMSIs) and associated authentication data such as one or more authentication key (Ki). These credentials may be stored in a profile data structure, or SIM profile, on the secure module of the subscription device. IMSIs have been widely used to enable MNOs or MVNOs, to identify individual subscribers and, along with the relevant authentication data, make decisions to accept or reject attach requests from subscription devices. Typically, a network node will process an IMSI and associated authentication data included in an attachment request to determine whether a given subscription device is to be allowed to attach to the network for service. If the subscription device is roaming in a cellular network that is not their home network, or carrier core network (e.g. operated by their carrier service provider), then an authentication request may be forwarded from the cellular network in which the subscription device is roaming to their carrier core network.

IMSIs generally include three portions each represented by a subset of the total number of digits included in the IMSI. These portions include a mobile country code (MCC), a mobile network code (MNC), and a mobile subscriber identification number (MSIN). In some cases, a subscription device may include a multi-IMSI SIM, or multi-IMSI SIM profile that includes a plurality of IMSIs. The plurality of IMSIs may include IMSIs having different MCCs and/or MNCs. Multi-IMSI SIMs allow a subscriber to have and use IMSIs which are associated with the country in which the subscription device is currently located. For example, a mobile network operator, with which a user has a subscription for cellular services, may have agreements with mobile network operators in other countries, or regions, to provide specific services, billing functions, and customer services to their users when they are travelling abroad. The services, prices, and quality of service may be optimised according to the location of the subscription device 200 and the plurality of IMSIs available in the device 300.

The range of available IMSIs is finite due to the fixed length of IMSIs and the possible permutations, taking account of restrictions based on MCC, and other criteria. As such, the exhaustion of the total number of available IMSIs raises a potential problem for mobile network operators. Multi-IMSI SIMs may be used to provide a solution for the falling number of available IMSIs when used with shared IMSIs. Multi-IMSI SIMs may be provided with profile data structures including one or more shared IMSIs, as well as one or more private IMSIs. A private IMSI is an IMSI which is available only to a specific subscriber, or subscription device, at a given time. That is to say that a private IMSI may be included in only one profile data structure provided to a subscription device. In some cases, a private IMSI may be re-distributed if it is determined that the subscription device that had been assigned the private IMSI is no longer in need of said private IMSI.

Shared IMSIs may include IMSIs which are available for use by a plurality of subscription devices at the same time. For example, a given shared IMSI may be included in a profile data structure that is provided to two or more subscription devices at the same time. That is to say that two subscription devices may be provided with an overlapping set of shared IMSIs, which in some cases may be the same set of shared IMSIs. In other examples, each subscription device may be provided with a unique profile data structure that has been constructed based on a pool of available IMSIs from which other profile data structures are also constructed. This may result in a plurality of profile data structures which differ from each other based on at least one IMSI.

In this case, the IMSIs which are selected to be included in profile data structures may be selected at least partly randomly. For example, each profile data structure may include a set of private IMSIs, and one or more subsets of shared IMSIs, at least one subset of shared IMSIs including an IMSI selected randomly from the pool of IMSIs.

Shared IMSIs enable mobile network operators to re-use IMSIs for multiple subscription devices, thereby allowing more subscription devices to obtain cellular network connectivity while mitigating an increase in the total number of IMSIs that would otherwise be used. For example, certain subscription devices may use some IMSIs only for a limited period of time, such as when the subscription device is roaming in a visited network. In this case, a subscription devices may be provided with private IMSIs associated with their home network, or country, in which they most frequently connect to and use cellular network connectivity, and may be provided with shared IMSIs associated with other countries, or regions, in which these subscription devices may travel less frequently.

It has been found that using shared IMSIs can lead to situations in which the cellular network service provided to a given subscription device can be interrupted, leading to a degradation in service. Certain examples, described herein, provide methods and apparatus to handle attach requests from subscription devices in a manner which provides less obstruction and interruption of cellular network service provided to these subscription devices. Certain other examples described herein enable subscription devices to recover quickly, and autonomously, from events in which cellular network service is interrupted, such that minimal impact is felt at the device 300.

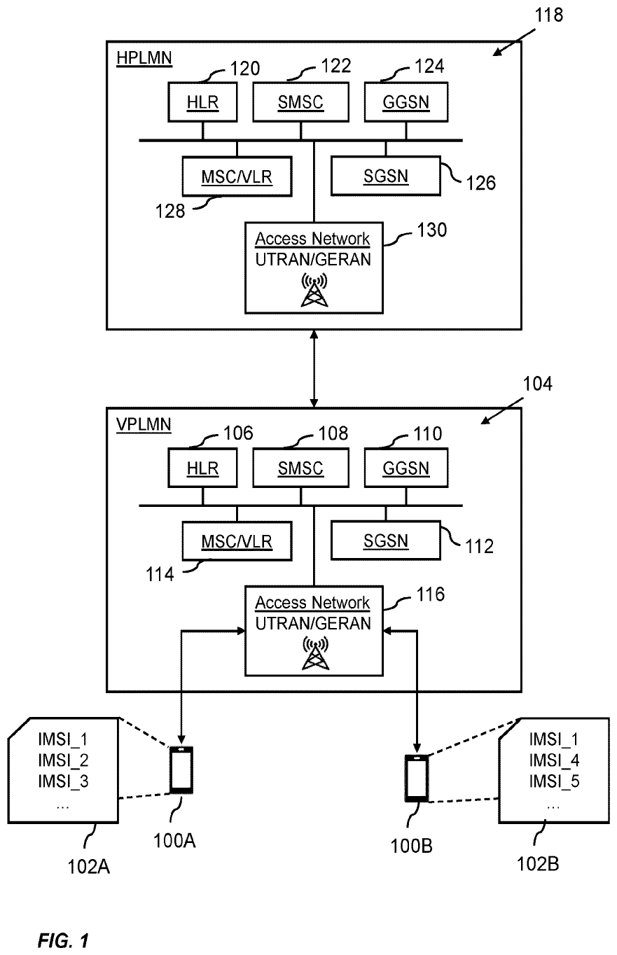

FIG. 1 shows an example of a network environment in which methods and devices of the present disclosure may be implemented. Two subscription devices 100A and 100B comprising multi-IMSI SIMs 102A and 102B, or SIM profiles, when registering for service with a cellular network 104 are in communication with a cellular network 104. In the example shown, the cellular network 104 is implemented in a Visited Public Land Mobile Network (VPLMN). A Public Land Mobile Network (PLMN) is a geographical area covered by a mobile network operator for voice and data services to subscription devices 100A, 100B. The VPLMN is a PLMN in which is not the home PLMN of the subscription devices 100A and 100B. For example, a subscription device may be first registered in the UK and a cellular network subscription may be purchased from an MNO operating in the UK. When travelling to a different country, the local PLMN in that travelled to country may be operated by a different MNO and is considered to be a VPLMN to the UK based subscription devices 100A and 100B. In the example shown, the subscription devices 100A and 100B are both attempting to attach to, or are in communication with, the same network 104. Though it is to be appreciated that the devices 100A and 100B may be in communication with different networks, in different regions, or different countries.

The cellular network 104 includes a Home Location Register (HLR) 106 for home subscribers of the cellular network 104 that stores subscription information for subscribers, including that relating to SMS, data, and voice services. The HLR may be updated with the location of the subscription device during roaming. A Short Message Service Centre (SMSC) 108 is a network element that stores, forwards, and deliver Short Message Service (SMS) messages. A Gateway GPRS Support NOTE (GGSN) 110 is provided that connects the GSM-based 3G networks to the internet. The GGSN works in tandem with a Serving GPRS Support Node (SGSN) 112 to keep subscription devices connected to the Internet and IP-based applications. The Mobile Switching Centre (MSC) and Visitor Location Register (VLR) functions 114 provide a telephone exchange that makes the connection between subscription devices within the network 104, to the public switched telephone network, and to subscription devices in other networks. The VLR in particular, includes a database that contains information about subscription devices roaming within the VPLMN. The nodes in the cellular network 104 may be configured to communicate over standards-based communications such as SS7/GTP/Sigtran, or any other protocols defined by the mobile communication standards bodies.

The cellular network 104 also includes an access network 116 that connects subscription devices 100A and 100B to the core network 106 to 114. Subscription devices 100A and 100B may generally be configured to communicate with the access network 116 over a wireless radio interface. The access network 116 may be a common access network 116 that is connected to a plurality of cellular networks providing service in a given geographical region.

A further cellular network 118 is also shown that is a home network for the subscription devices 100A and 100B. The further cellular network 118 includes corresponding components including an HLR (120), SMSC (122), GGRS (124), SGSN (126), MSC/VLR (128), and an access network (130). The home cellular network 118 and the visited cellular network 104 are in communication with one another over a communications interface that may include wired and/or wireless communication devices, or technologies.

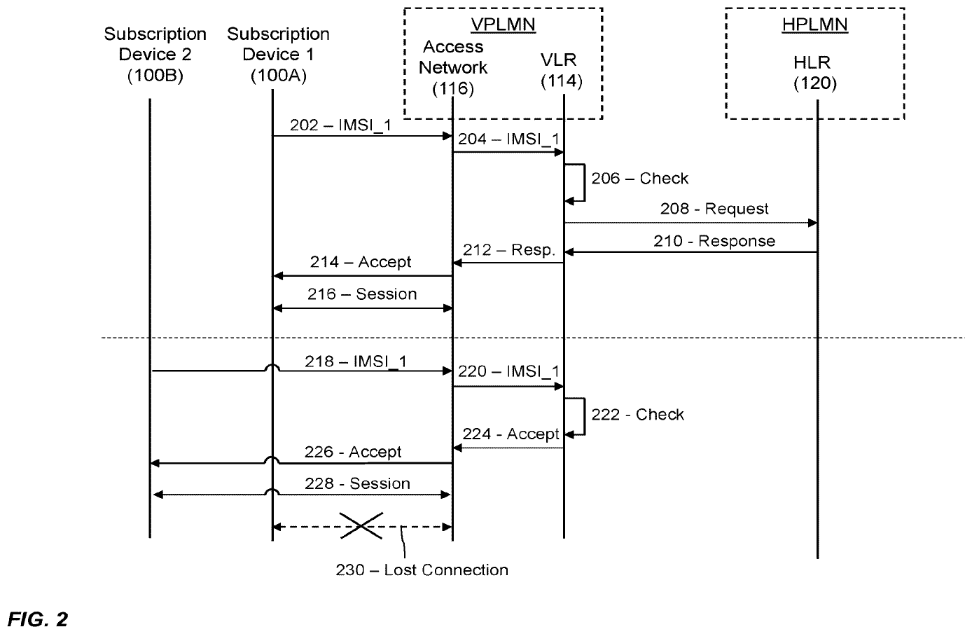

Turning to FIG. 2, a sequence diagram showing a sequence of attach requests from the subscription devices 100A and 100B is shown, in which a first device attaches to a cellular network and subsequently loses their connection when a second device attaches to the network. At a first step the first subscription device 100A selects an IMSI from the Multi-IMSI SIM 102A and sends an attach request 202 to attach to the cellular network 104. The attach request includes the selected IMSI and authentication data used to determine whether the subscription device is entitled to service. The attach request is received by the access network 116 and forwarded 204 to the VLR 114. The VLR 114 checks 206 a database, including cached authentication vectors, to determine whether the selected IMSI has already been authenticated and registered for service with the cellular network 104. If no such record, indicative of the registration of the selected IMSI can be found, the VLR may communicate 208 with an HLR 120 to authenticate the request and determine whether the subscription device 100A is authenticated and/or entitled for service. The HLR 120 responds 210 to the request 208 from the VLR 114 confirming that the subscription device 100A may be registered for service using the selected IMSI. The VLR 114 accepts the attach request and responds 212 and 214 to the subscription device 100A. A session 216 may then be initiated with the subscription device 100A enabling it to use services provided via the cellular network 104.

As described above, the subscription devices 100A and 100B may include Multi-IMSI SIMs 102A and 102B, and in the example shown, the two devices 100A and 100B include at least one matching shared IMSI, IMSI_1. At a time after the first subscription device 100A has registered for service with the cellular network 104, and before the session for 100A is closed, the second subscription device 100B selects the same IMSI, IMSI_1, and sends an attach request 218 to the cellular network 104 that is relayed 220 by the access network 116 to the VLR 114. The VLR 114 may then check 222 to see if a registration with the IMSI_1 has already been made. In this example, the VLR 114 determines that the IMSI_1 is registered for service, based on the records generated during the registration of the first subscription device 100A. The VLR 114 accepts 224 and 226 the attach request from the second subscription device 100B and a session is initiated 228. This procedure may be as described in TS 129 118 ETSI. In this circumstance, the session for the first subscription device 100A is lost 230 and the first subscription device 100A loses service.

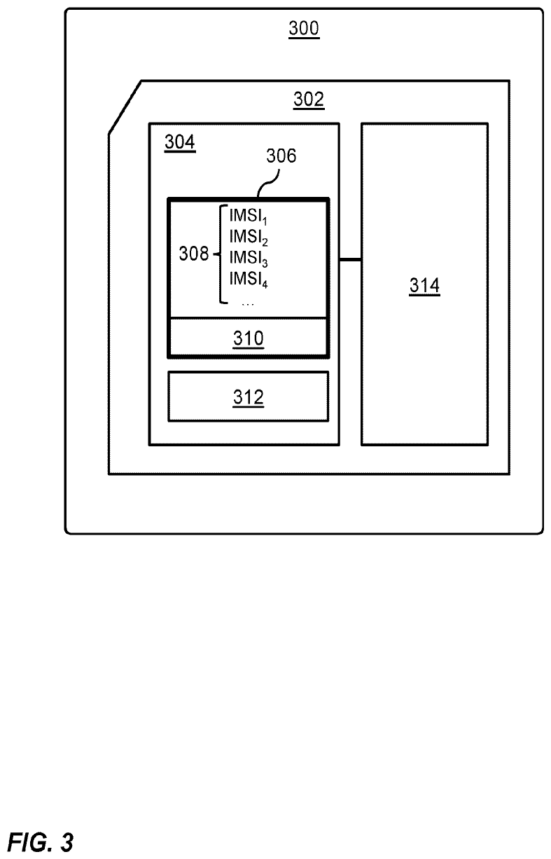

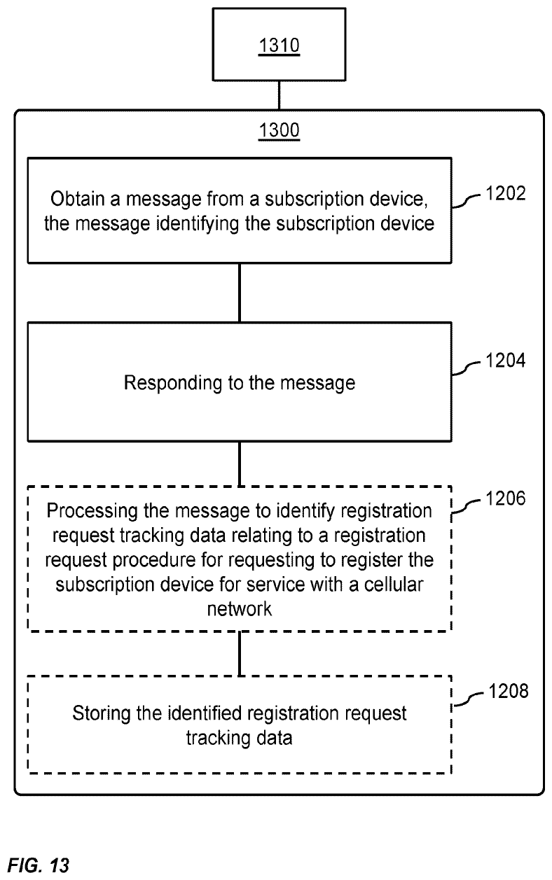

An event in which a subscription device 100B registers for service with a cellular network 104 using an IMSI that is already being used for an active registration of another subscription device 100A may be referred to as a collision. When a collision occurs, the response of the cellular network 104 may be determined based on that network's capabilities, which are not the same in all networks. Generally, a cellular network 104 that does not recognise these collision events, and/or which does not communicate with the HLR 120 of the home network for the subscription device(s) 100A (100B) to determine how to respond, may accept the new attach request and the first subscription device 100A will lose service. Cellular networks 104 which do not recognise these collision events may instead handle these as re-attach requests, assumed to be from the same device. As the use of shared IMSIs increases amongst subscription devices the likelihood of collisions may also increase. Certain examples, as will now be now be described with respect to FIGS. 3 and 13, aim to provide systems and methods for subscription devices 100A and 100B to handle these collision events in a way which aims to reduce the period for which service is not provided to a subscription device. In some examples, the methods described may also enable data to be collected that empowers service providers to provision and manage profile data structures in subscription devices 100A and 100B in a manner that can reduce the likelihood of collision events occurring and/or to manage attach requests based on the current conditions in the network with respect to the number of shared IMSIs in use.

### Device Side Procedures

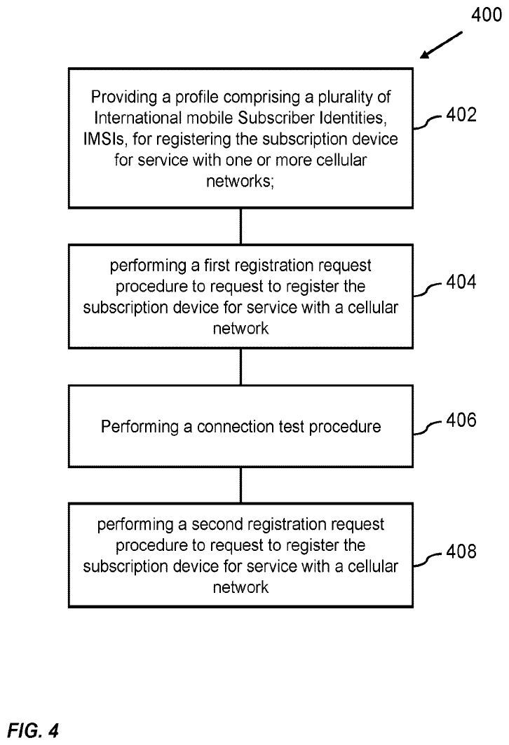

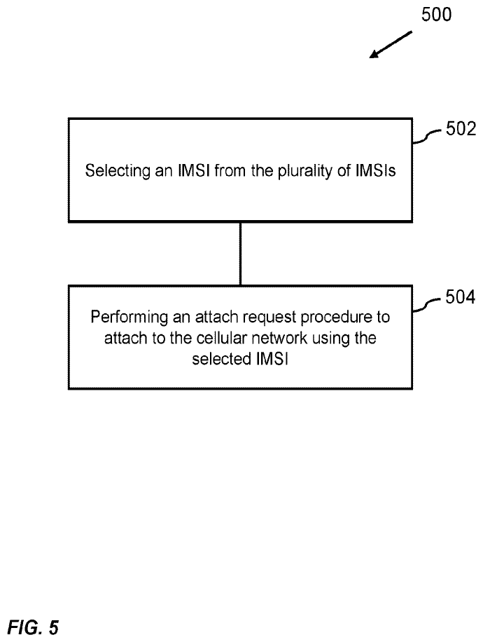

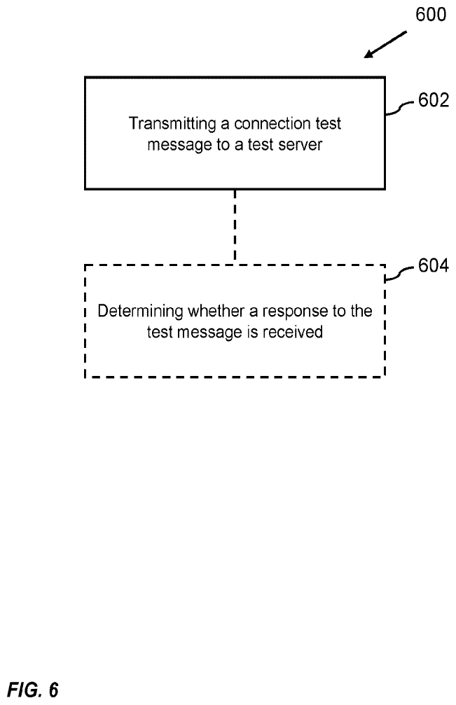

FIG. 3 shows an example of a subscription device 300 in which a computer-implemented method 400, shown with the use of flow chart in FIG. 4, may be implemented. FIGS. 5 and 6 show examples of sub procedures performed by the method 400 as will be described further below. The subscription device 300 includes a secure module 302 as described above, which may be a UICC, an eUICC, an iUICC, a soft-SIM, and so forth. The secure module 302 includes storage 304 on which is stored a profile data structure 306, referred to also as a SIM profile 306 or simply as a profile 306, comprising a set of IMSIs 308, and authentication data 310. The storage 304 may also store a set of executable instructions 312 for performing one or more procedures of the method 400. The instructions 312 may also include one or more additional programs or applets. The secure module 302 includes one or more processor 314 that may execute the instructions 312 to run the one or more procedures, programs, or applets.

Referring now to the method 400 for requesting to register a subscription device 300 for service with one or more cellular network 104, the subscription device 300 may be configured to provide 402 a profile 306 comprising a plurality of IMSIs 308 for registering the subscription device 300 for service with one or more cellular network.

The profile 306 may be initialised on boot-up of the subscription device. In some cases, the subscription device 300 profile 306, in the device 300 may be reset, or re-initialised, following certain events for the subscription device 300. For example, when coming out of a restricted connectivity mode, or “airplane mode”, on boot-up of the device 300, on, or shortly after, the device 300 is moved to a new geographic region, or on instruction from a user. The subscription device 300 may be pre-provisioned with the profile 306, which is to say that the profile 306 may be stored on the device 300 during manufacture such that it is included in the device 300 when provided to a user. In other cases, the profile 306 may be downloaded by the subscription, for example, using remote SIM provisioning (RSP) techniques, such as those specified according to GSMA specifications and accreditation.

The subscription device 300 is configured to perform 404 a first registration request procedure 500 to request to register the subscription device 300 for service with a cellular network 104.

The registration request procedure 500, shown in FIG. 5, comprises, selecting 502 an IMSI, in this case a first IMSI, from the plurality of IMSIs 308. An attach request procedure is then performed 404 to attach to the cellular network 104 using the first IMSI. The attach request procedure may include transmitting a request to a cellular network node to request to register the subscription device 300 for service with the cellular network 104 using the first IMSI and associated authentication data 310. There are two possible outcomes of the first registration request 500, the first outcome being that the subscription device 300 is successfully registered for service with the cellular network 104. Alternatively, the second outcome is that the subscription device 300 is not successful in registering for service with the cellular network 104 using the first IMSI.

If the attach request procedure 504 is successful, then the subscription device 300 is successfully registered for service and may utilise the services provide via the cellular network 104. If the attach request is unsuccessful, the subscription device 300 will typically not be provided with cellular network connectivity and services such as voice, data, and SMS may not be available to the subscription device 300.

In some examples, a specific algorithm may be provided for selecting 502 the IMSI. This algorithm may include a selection procedure that prioritises IMSIs that are associated with a current location of the subscription device 300, for example, including a corresponding MCC or MNC associated with the VPLMN in which the subscription device 300 is located or to which the subscription device 300 communicates. In other examples, a random, or semi-random, process may be used to select 502 an IMSI.

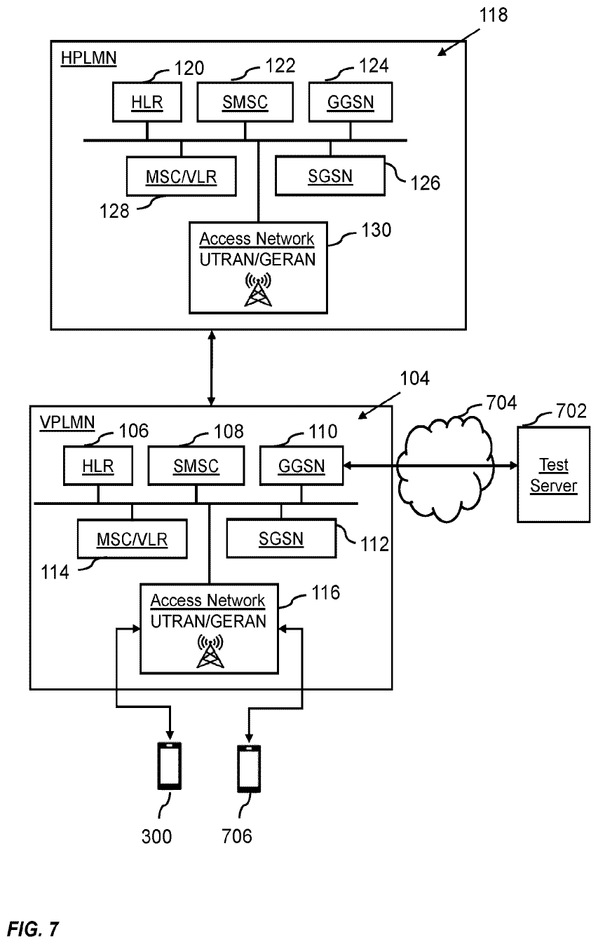

The subscription device 300 performs 406 a connection test procedure 600, shown in more detail in FIG. 6. The connection test procedure 600 includes transmitting 602 a connection test message to a test server. Turning briefly to FIG. 7, an example test server 702, to which the test message may be sent, is shown in relation to the cellular network 104. As can be seen, the test server 702 may be in communication with the cellular network 104 over the internet 704 or alternative network communications network hardware. The test message may be transmitted to the cellular network 104 to which the device is attempting to attach, to be forwarded, or transported, to the test server 702.

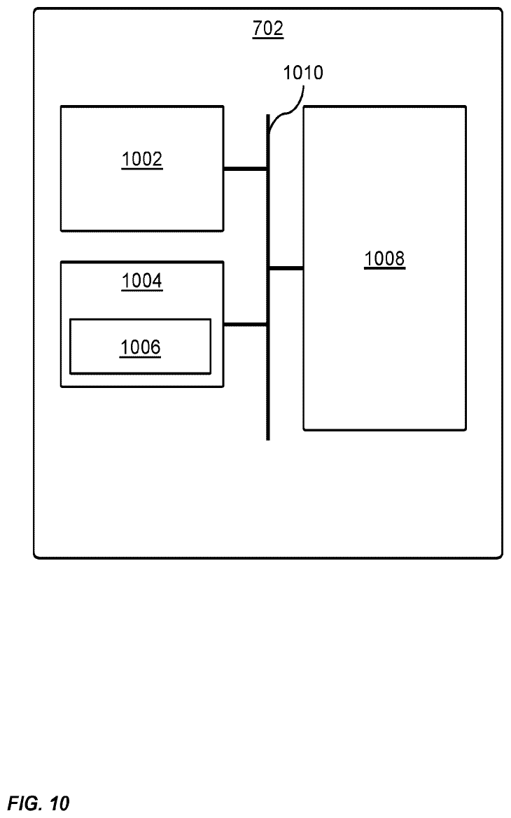

In some examples, not shown in FIG. 7, the test server 702 may be included in the cellular network 104 or may be part of the home cellular network 118, also referred to as the carrier network or carrier core network, of the subscription devices 300 and 706. The connection test procedure 600 may be used to determine whether the subscription device 300 is able to access and/or operate services provided by the cellular network 104. The function of the test server 702 will be described further below with respect to FIG. 10.

Based on an outcome of the connection test procedure 600, the subscription device 300 may perform 408 a second registration request procedure 500 to request to register the subscription device 300 for service with a cellular network 104. The second registration request procedure 500 includes selecting 502 a second IMSI from the plurality of IMSIs 308. The device 300 then performs an attach request procedure to attach to the cellular network 104 using the second IMSI. The second registration request procedure 500 is triggered in dependence on receipt of a response to the connection test message. In a preferred embodiment, the subscription device 300 performs the second registration request procedure 500 if no response to the test message is received from the test server 702. In other examples, the second registration request procedure 500 is performed if a response to the test message is received after a threshold period of time from when the test message was transmitted 602.

The connection test procedure 600 may be used in conjunction with the first and second registration request procedures 500 in multiple ways. In a first example, the connection test procedure 600 is performed substantially concurrently, or at least partially concurrently, with the first registration request procedure 500. For example, at, or shortly after, the start of the first registration request procedure 500. Alternatively, the connection test procedure 600 may be performed a predetermined period of time after the first registration request procedure 500 is performed 404 such that it if the first registration request 500 was successful, the device 300 can be expected to be registered for service with the cellular network 104. Where the attach request procedure, performed in the first registration request procedure 500, is unsuccessful, the connection test procedure 600 determines that the subscription device 300 is not registered for service with cellular network, based on a lack of response to the test message, and can cause the triggering of the second registration request procedure 500.

The second IMSI, selected during the second registration request procedure 500, may be a different IMSI to the first IMSI. For example, when selecting a second IMSI, the first IMSI may be excluded from a pool of potential IMSIs selected from the plurality of IMSIs. If the first registration request procedure 500 is unsuccessful the likelihood of successfully attaching to the network 104 using the first IMSI may be diminished and hence selecting a second, different, IMSI may increase the likelihood of successfully attaching when performing 408 the second registration attach procedure 500.

In some examples, the connection test procedure 600 includes determining whether a response to the test message has been received within a predetermined period of time. In this case, a response period may be defined, within which a response to the test message is to be received. The response period may be based on a maximum expected response period, which may in turn be dependent on the average time for a response to be generated and transmitted by the test server 702, and travel through the network to the subscription device 300. Alternatively, the response period may be based on an expected period for an attach request procedure to be successful. The period may be dependent on a device type, as will be described further below. If the subscription device 300 does not receive a response to the test message within the response period, then it may be determined that no response to the test message has been received. While thirty seconds is provided as an example above it is to be appreciated that a different period may be determined based on different use cases. For example, when implementing the method in a battery constrained device, a longer response period may be used to reduce the battery consumption of the device. In devices for which an active cellular network connection is critical, a shorter response period may be used to accelerate the network attachment times.

When performing an attach request, as in the first registration request procedure 500, the subscription device may not be readily notified that the attach request has been unsuccessful. By using the connection test procedure 600 to trigger the performance of the second registration request procedure 500 it becomes possible to reduce the idle time of the subscription device 300 before it is determined that the first attach request was not successful. This in turn allows the subscription device 300 to quickly select and use a second IMSI to attach to the network 104, thereby reducing the total time for which the subscription device 300 does not have an active cellular network connection.

In a second example, the first registration request procedure 500 is successful, and the subscription device 300 attaches to the network 104 and is registered in association with the first selected IMSI. In this case, the connection test procedure 600 may additionally, or alternatively, be implemented after the successful performance 404 of the first registration request procedure 500 to check whether the subscription device 300 continues to have cellular network service on an ongoing basis. To this end, the connection test procedure 600 may be performed repeatedly. After the transmission of each test message, the subscription device 300 may be configured to determine 604 whether a response to the test message is received by the subscription device 300. If a response is received, then the subscription device 300 may perform a further connection test procedure 600. If no response to the test message is received, then the second registration request procedure 500 is triggered in an attempt to re-establish a cellular network connection such that the subscription device 300 is able to access cellular services, such as voice, data, and SMS.

By repeatedly, and in some cases periodically, testing whether the device 300 has access to cellular network services using the connection test procedure 600, it becomes possible to identify whether the subscription device 300 loses its service from the cellular network 104 faster. Thereby mitigating the amount of down time experienced when another subscription device 706 registers with the cellular network 104 using the same IMSI (the first IMSI) as the subscription device 300. The connection test procedure 600 may run as a background process on the subscription device 300 such that it operates to test the connection and trigger the second registration request procedure 500 while a user is not actively using the device 300, or while the device is not actively using a cellular connection, and may not be aware of the drop in service provided by the cellular network 104.

The connection test procedure 600 may similarly be performed substantially concurrently, or partially concurrently, with the performance 408 of the second registration request procedure 500 to determine whether it 500 is successful or whether a further registration request procedure 500 is to be performed.

The connection test procedure 600 may be performed periodically with a predetermined interval between performances of the connection test procedure 600. In one example, each connection test procedure 600 may be performed immediately after the end of the previous connection test procedure 600. This may be implemented where the connection test procedure 600 is used to test an ongoing connection of the subscription device 300 with the cellular network 104.

In some cases, the predetermined interval may be dependent on a device type corresponding to the subscription device 300. For example, where the subscription device 300 is a mobile device including a battery, the predetermined interval may be longer. Periodically performing the connection test procedure 600 may increase the computing load on a subscription device 300. Where a subscription device 300 is a mobile device such as a smartphone, or in device with much more restrictive battery capabilities, there may be a finite amount of power that the device is able to use before it needs to be charged. Hence, the frequency of performing the connection test procedure 600 may be lower to conserve battery life, or to free up processing resources for other functions. This is achieved by setting the predetermined interval to be longer. In contrast, IoT devices, or smart appliances, which are generally plugged into mains power supplies, or have large batteries, may perform the connection test procedure 600 more frequently as there are fewer, or no, constraints on power consumption. In other examples, IoT devices may be de-prioritised as compared to handheld mobile devices and hence the predetermined interval may be longer to reduce the traffic received at the test server 702 and to free up the test server 702 to respond to requests from handheld mobile devices.

Other considerations include the frequency with which a subscription device 300 is used. For example, smartphones may be used very frequently and hence may be configured with a short interval between connection test procedures 600 such that the device is more likely to have active cellular network connectivity when it is needed and thereby provide a better service to a user. Other subscription device 300 types, such as a smart appliances, may use their cellular network connectivity infrequently, hence it may be acceptable to have longer periods without an active cellular network connection.

In some cases, the predetermined interval may be variable, such that power consumption and network load can be balanced. To this end, the method 400 may include determining one or more characteristics associated with the subscription device 300 and modifying the predetermined interval in dependence on the one or more characteristics. The characteristics may include, an available energy level remaining in a battery of the subscription device 300, a power supply to the subscription device, an indication of a device type, usage statistics associated with the subscription device 300 such as the frequency with which cellular network connectivity is used, current processor load, and so forth.

In examples where the connection test procedure 600 is performed under multiple conditions, such as when performing 404 the first registration request procedure 500, and after the first registration request procedure has been successful, response period may be variable. For example, a shorter response period may be used when the connection test procedure 600 is performed concurrently with the first registration request procedure, and a longer response period may be used when the connection test procedure 600 is performed after successfully registering for cellular network service by performing 404 the first registration request procedure 500.

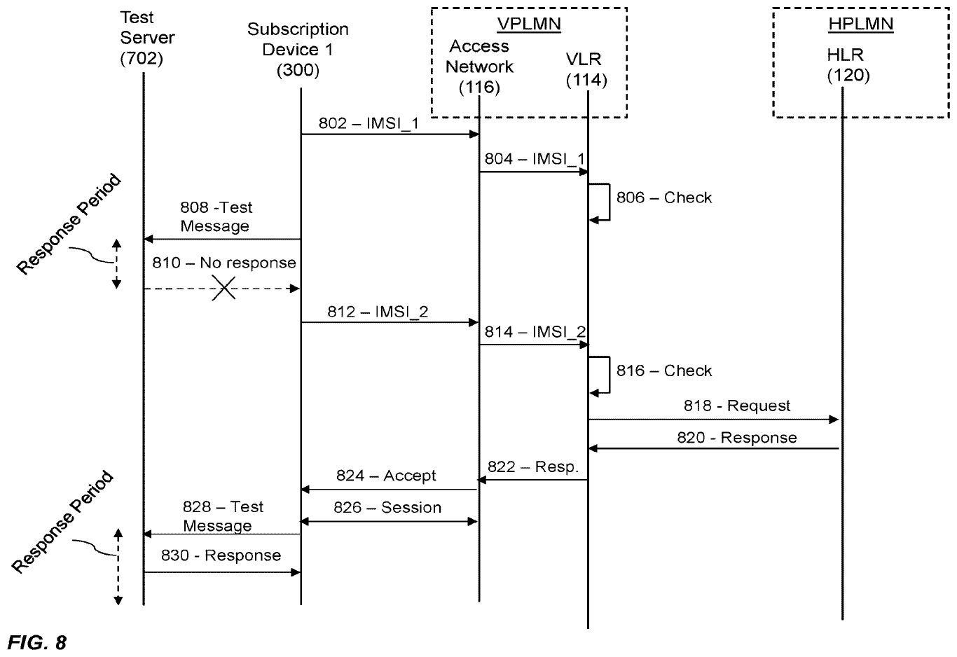

FIG. 8 shows a sequence diagram of an example implementation in which the connection test procedure 600 is performed substantially concurrently with the performing 404 of the first registration request procedure 500 and the second registration request procedure 500. The first registration procedure 500 is performed in which a first IMSI is selected and an attach request procedure is performed including transmitting 802 a request into a network node 116. In this case there is a significant delay in the processing of the request in the network 104 and hence a significant delay in receiving a response to the request. The subscription device 300 transmits 808 the test message to the test server 702. After the response period has elapsed since the test message was transmitted, no response 810 was received by the subscription device 300 and hence the subscription device 300 triggers the second registration request procedure 500. A second IMSI is selected and following the signalling 812 to 826 the subscription device is successfully registered for service with the cellular network 104, and a subsequent connection test procedure 600 is performed 828, 830 and it is determined that cellular network connectivity is successfully provided to the subscription device 300.

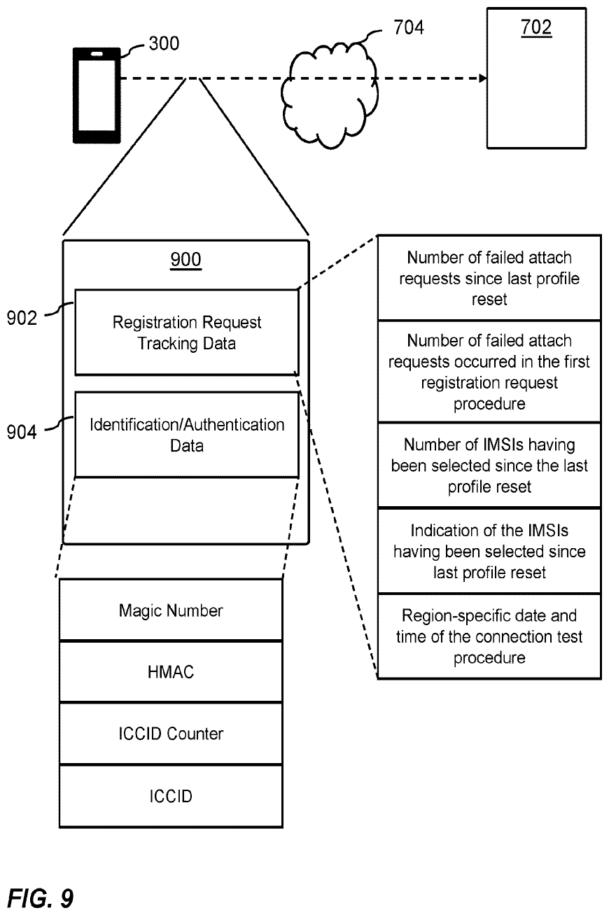

In some examples, the, or each, connection test message comprises registration request tracking data. FIG. 9 shows an example of a connection test message 900, the connection test message 900 including registration request tracking data 902 and in some cases may also include data 904 that can be used to identify the device 300 and ensure that the test server 702 responds to legitimate test messages 900 from suitable subscription devices 300. The request tracking data 902 may be used to keep a record of registration request statistics that are indicative of the operation of the subscription device 300. By tracking statistics relating to the registration request procedures 500, performed by the device 300, it becomes possible to identify when a quality of service for the device 300 degrades. In particular, an increase in the frequency of registration requests 500 performed by a device 300 may be readily identified. An increase in the frequency of registration requests 500 is generally undesirable as it may be associated with the device 300 undergoing longer or more frequent periods without having service provided by a cellular network 104. Other examples include being able to identify the frequency of failed attach request procedures performed with certain IMSIs. Where the frequency of failed attach requests procedures using a given IMSI increases, this may be an indication that the IMSI has been provided to a certain number of subscription devices such that it is being selected and used too frequently and causing a degradation in the service provided to certain subscription devices. This may indicate that the IMSI should be avoided in new profiles.

Transmitting this request tracking data 902 in a test message 900 provides a channel for this data to be signalled into the cellular network 104, and/or to an MNO, or other service provider who manages the subscription device 300 and the profile 306 provided therein. The MNO, or other type of service provider, may then use this tracking data 902 to modify or tune the production of profile data structures 306 that are provided to other devices 706. The service provider may also modify the profile 306 stored in the subscription device 300 for example to update the IMSIs provided therein, to reduce the frequency with which the device 300 loses service from the cellular network 104, and/or to increase the speed with which the device 300 is able to reconnect to the cellular network 104 following a loss of service. This may be done by using RSP techniques and transmitting updated profile 306 data to the subscription device 300 that includes IMSIs that have been provided in fewer profiles than the IMSI previously comprised in the profile 306. Where the tracking data 902 is indicative of attach requests using a given IMSI failing more frequently as compared to attach requests using other IMSIs, the MNO, or other type of service provider, may de-prioritise that given IMSI when producing profiles for other devices 706, such that it is less likely to be provided to other devices 706.

By transmitting the registration request tracking data 902 to the test server 702 it becomes possible to improve the service provided to subscription device 300 and 706 by tuning the variation in IMSIs provided to certain subscription devices while aiming to keep the total number of IMSIs used low.

The registration request tracking data 902 may include a plurality of data elements in the form of byte sequences which are configured to represent specific information used to track the registration request procedures. The tracking data 902 may include an indication of a number of failed attach request procedures having occurred in the first registration request procedure. This indication may be included in the form of a 1-byte length counter. In some examples, the first registration request procedure may include re-attempting the attach request procedure using the first IMSI after an initial unsuccessful attach request procedure.

The tracking data 902 may include an indication of the number of failed attach request procedures having occurred since a previous reset of the profile, and/or a number of failed attach requests procedures since the device 300 was last successfully registered for service with the cellular network 104. As described above, the profile 306 may be reset following certain events, such as on a re-boot of the device or when changing geographic location of the device 300. In this case, the method 400 may be performed repeatedly while attempting to attach to the cellular network 104. The registration request tracking data 902 may include a counter that counts the total number of failed attach request procedures since the profile 306 was last reset.

The tracking data 902 may additionally, or alternatively, include an indication of a number of IMSIs having been selected since the previous reset of the profile 306. For example, where the method 400 is performed repeatedly, the total number of IMSIs that have been selected may be counted and included in the tracking data 902. Where a large number of IMSIs have been selected since the last reset of the profile 306, this may be an indication that the IMSIs included in the profile 306 are concurrently in use by a large number of other subscription devices 706 and as such are leading to a degradation in service provided to the subscription device 300 due to an increase in collision events.

The tracking data 902 may also include an indication of the IMSIs that have been selected since the previous reset of the profile 306. These IMSIs may include the first IMSI, selected during the first registration request procedure 500. Additionally, this may include the IMSIs selected in previous registration request procedures 500 that have been performed since the last reset of the profile 306. In this way, it becomes possible to track which specific IMSIs are being used along with the statistics relating to their frequency of successfully or unsuccessfully being used in attach requests to the network 104. The indication of the IMSIs used may include a set of one or more index references which refer to record numbers of a database in which the IMSIs values are stored. Sending an index reference associated with each IMSI rather than the actual IMSI value may mitigate an increase in the size of the test message 900 compared to implementations where the IMSI values themselves are included in the test message 900, for example, while each IMSI value typically includes 14 to 15 digits, the index reference for an IMSI may be represented using one byte in the test message 900. Where there are N number of IMSIs that have been used since the last reset of the profile, there may be N bytes used to indicate the values of the IMSIs that have been selected since the last reset of the profile.

The tracking data 902 may also include a region-specific date and time of the connection test procedure, which is associated with the region, or country, in which the subscription device 300 is located. The date and time may be encoded in the tracking data 902 according to ETSI TS 102 223. Including date and time information in the tracking data 902 may enable trends in the operation of the registration request procedures 500 that are time variant to be identified. For example, trends in the frequency and/or success and failure rate of registration request procedures 500 may be temporally correlated, such that at certain times of day the frequency of registration request procedures 500 may change. These frequencies may correlate to trends over different periods than a day, for example, over a week, a month, or over irregular time periods.

Receiving tracking data 902 that can be used to identify time variant trends in the collision events between devices can be used to tune the provision and management of profiles 306 on subscription devices 300 to reduce the frequency of collision events while ameliorating potential increases in the total number of IMSIs provided to subscription devices 300, 706. One such example, may be that data is provided with a profile data structure 306 that indicates temporal dependent characteristics of IMSIs, such that certain IMSIs are prioritised at different times over other IMSIs during the selection of an IMSI in the registration request procedures 500.

The tracking data 902 may also be used to a different end than to tune the provision and management of profiles 306. The tracking data 902 may alternatively, or additionally, be used to provide insight to the home core network of the subscription devices 300 to enable decisions to be made regarding the acceptance or denial of attach requests that may benefit the overall performance of the network. This will be described in more detail in the following section relating to “Network Side Procedures” but in summary, there are some circumstances where a home network 118 of the subscription device 300 is consulted when handling an attach request even where the VLR 114 determines that a registration request using the same IMSI as the attach request has previously been accepted. In this circumstance, the tracking data 902 may be used to revise and otherwise tune the algorithms governing whether attach requests are to be accepted.

The data 904 used to identify the device 300 and/or authenticate it to the test server when sending test messages, may include a number of different data values which can be used alone or in combination to ensure that test message 900 is received from an authorised device 300 and to prevent overloading of the test server 702 from replay attacks. For example, the data 904 may include a magic number that is shared between the device 300 and the test server ad-hoc. The magic number may be 2 bytes in length. The data 904 may include a Hash-based Message Authentication Code (HMAC) that is a cryptographic tool that combines public keys, private keys, and a hash into a mixed value that is resilient to reverse engineering, and otherwise decoding from unauthorised actors.

The data 904 may include an Integrated Circuit Card ID (ICCID) counter that is associated to a specific ICCID, in this case the secure module 302, to avoid replay attacks. For example, the test server may be able to determine whether the same device is sending very frequent requests which may be an indication that they are not legitimate. The data 904 may include the ICCID of the secure module 302, encoded according to ETSI TS 102 221.

While the preceding description of the method 400, described with respect to FIGS. 4 to 9, has been described as a method for a subscription device 300, it is to be appreciated that the secure module 302 comprised in the subscription device 300 may be configured to perform the method 400. For example, the secure module 302 may include instructions to perform the method 400 in the instructions 312 that are executed by the one or more processors 314. The secure module 302 may be configured to perform the method 400 when included in the subscription device 300 and while the subscription device 300 is in a powered-on state.

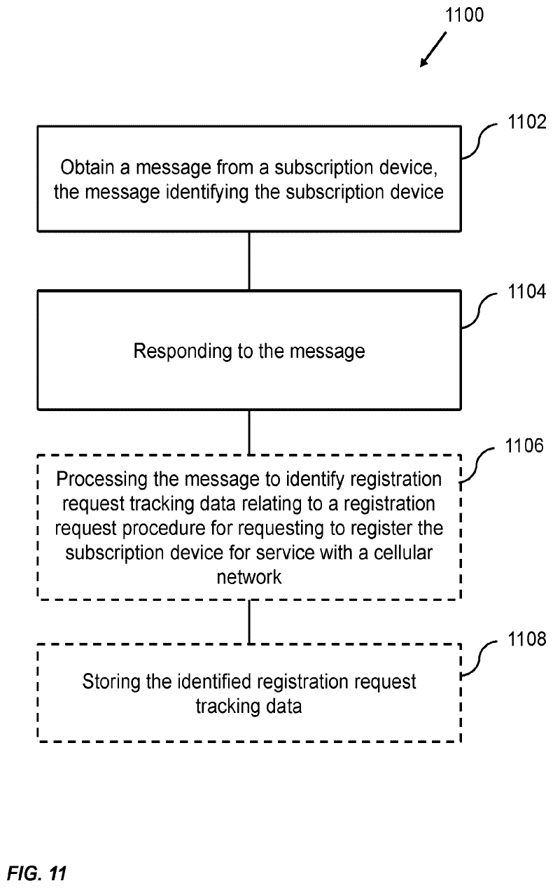

FIG. 10 shows an example of a test server 702 that performs a method 1100 shown in the form of a flow chart in FIG. 11. The test server 702 comprises a processor 1002 and storage 1004 on which is stored a set of computer-executable instructions 1006 which, when executed by the processor 1002, cause the test server 702 to perform the method 1100 for operating a connection test server 702. The test server 702 may additionally include one or more communications interfaces 1008 for communicating with wired and/or wireless networks such as the internet. The components in the test server 702 may be communicatively coupled over a bus 1010.

The method 1100 includes obtaining 1102 a test message 900 from a subscription device 300, the test message 900 including an indication of the subscription device 300. For example, the test message 900 may include an indication of an ICCID corresponding to a secure module 302 included in the subscription device 300. The test server 702 responds 1104 to the test message 900 to confirm receipt of the test message 900. In some examples, the test server 702 processes 1106 the test message 900 to identify registration request tracking data 902 relating to a registration request procedure performed by the subscription device 300. The test server 702 may store 1108 this registration request tracking data 902. Storing this tracking data 902 allows it to be used to tune the handling of attach requests and/or the provision of profiles 306 in the network. The identification 1106 and storing 1108 of the tracking data 902 is shown in the flow chart of FIG. 11 as occurring after responding 1104 to the test message 900. However, it is to be appreciated that these steps 1106 and 1108 may alternatively be performed before responding 1104 and/or substantially concurrently with responding 1104 to the test message 900.

The test server 702 may be configured to respond 1104 to the test message 900 before a pre-determined time period has elapsed since obtaining the test message. For example, where the subscription device 300 is expecting a response to the test message 900 within a first time period, to determine whether the device 300 has service provided by a cellular network 104, the period within which the test server 902 is configured to respond may be correlated with this first time period.

The pre-determined time period may be selectable, such that the test server 902 may respond to test messages 900 at different rates in dependence on criteria such as the type of device 300, the date and/or time, a specific instruction, and/or user input.

In some examples, the test server 702 may implement, or comprise, a Transfer Control Protocol echo client, or other suitable echo server application. The test server 702 may be a dedicated test server 702 for which the address, or URL, to which test messages 900 are sent maybe white listed to prevent charging subscription devices 300 based on their communications with the test server 702.

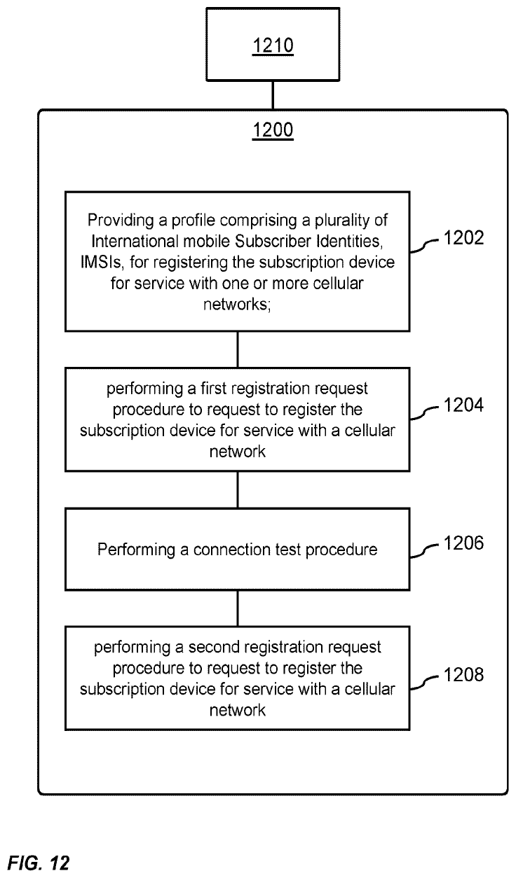

FIG. 12 shows a non-transitory computer-readable storage medium 1200 on which is stored a set of computer executable instructions 1202 to 1208 which, when executed by a processor 1210, cause the processor 1210 to perform a method 400 for requesting to register a subscription device for service with one or more cellular network. The storage medium 1200 may for example be included as in a secure module 302, such as SIM card, UICC, eUICC, iUICC, or soft-SIM. The processor 1220 may be included in the secure module 302. The various examples of the method 400 described above with respect to FIGS. 3 to 9 are also applicable to the set of instructions 1202 to 1208 included in the storage medium 1200.

FIG. 13 shows a non-transitory computer-readable storage medium 1300 on which is stored a set of computer executable instructions 1302 to 1308 which, when executed by a processor 1310, cause the processor 1310 to perform a method 1100 for operating a connection test server 1100. The various examples of the method 400 described above with respect to FIGS. 10 and 11 are also applicable to the set of instructions 1302 to 1308 included in the storage medium 1300. The storage medium 1300 may be integrated within a test server 702 or may be a removable, and/or portable, medium that can be inserted into, communicatively coupled with the test server 702 to instruct the server 702 to perform the method 1100.

### Network Side Procedures

In the examples described above in relation to FIGS. 2 to 13 the device side procedures are configured in attempt mitigate a period of time for which the device 300 loses service when a new device 706 registers with the cellular network 104 using the same IMSI as the first device 300. This generally occurs when the VLR 114 has cached authentication vectors relating to an IMSI which the subscription device 300 has used to attach to the network 104. However, in some examples, the VLR may be configured to pass an attach request to the carrier core network, in this case the home network 118 of the subscription devices 300 and 706. The carrier may also be referred to as the owner of the IMSIs in the plurality of the IMSIs as they manage the use of these IMSIs and provide them to their subscription devices 300 and 706.

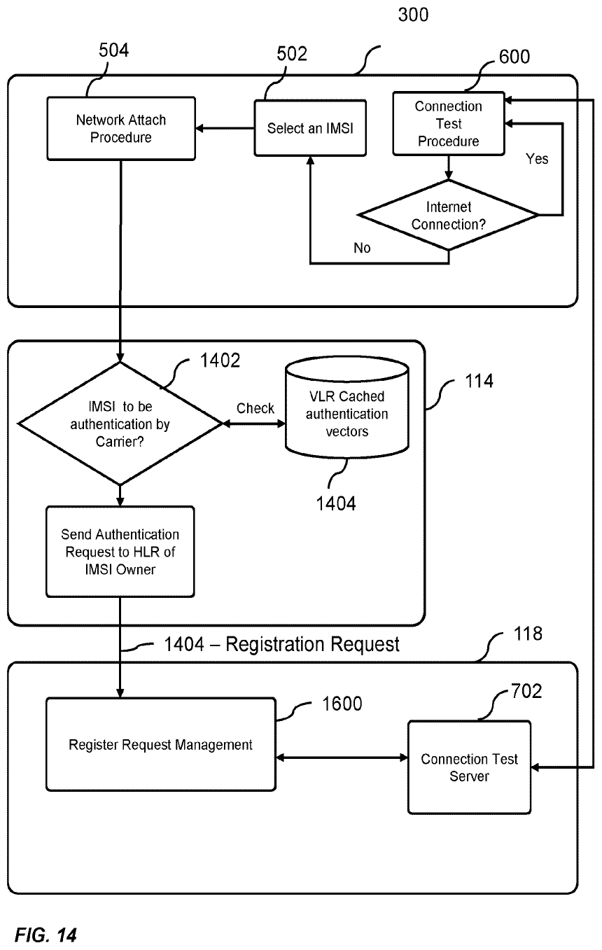

FIG. 14 shows an example in which a subscription device 300, uses a selected 502 IMSI in an attach request procedure 504 to request to attach to a network 104. The VLR 114 receives the request and determines 1402 whether the selected IMSI is to be authenticated by the carrier or whether the VLR is able to authenticate the request. The VLR 114 may check a stored cache 1404 of authentication vectors to determine whether the IMSI in question is already authenticated for service on the network 104. If a suitable record, or authentication vectors, are found, then the attach request may be authenticated. If a different subscription device 706 was using the IMSI in question, that is if a different subscription device 706 had registered for service on the network 104 using the IMSI, then that subscription device 706 may perform the method 400 described above to reattach to the network. In general, VLRs 114 may be configured to automatically authenticate an attach request if they have stored authentication vectors because in the majority of cases currently, where shared IMSIs are not used, the attach request will be received from the same device that originally registered for service.

If no cached authentication vectors, associated with the selected IMSI can be found then the VLR 114 may send an authentication request to the HLR 120 of the carrier core network 118, also referred to as the IMSI owner. The behaviour of VLRs 114 are not currently uniform in all regions and in some cases a VLR 114 may implement a policy that causes the authentication request to be passed to the carrier core network 118 even in the case that the VLR 114 has cached authentication vectors corresponding to the selected IMSI. This policy may be in force for all IMSIs, or in some cases, may be enabled for a specific subset, or specific range, of IMSIs.

In the circumstance that the VLR 114 sends the authentication request to the core network 118, the core network 118 may perform a method for managing requests to register subscription devices 300 and 706 for service with one or more cellular networks 104. Certain examples described herein provide methods and systems that handle registration requests in dependence on policies, or rules, that may differ based on characteristics of the requests. In this way, the core network can actively decide whether a given subscription device should lose service in favour of another device, whether it is likely that the newly received attach request is received from the same device that previously registered for service, and/or whether the likelihood of interrupting service can be reduced.

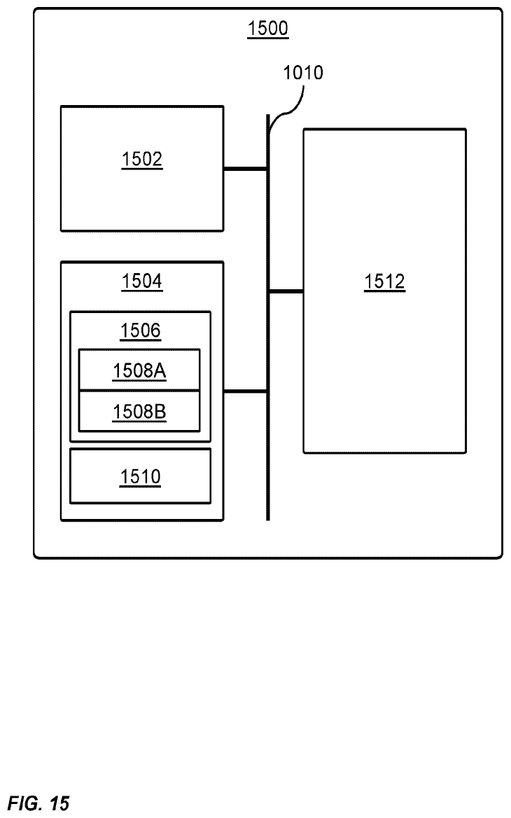

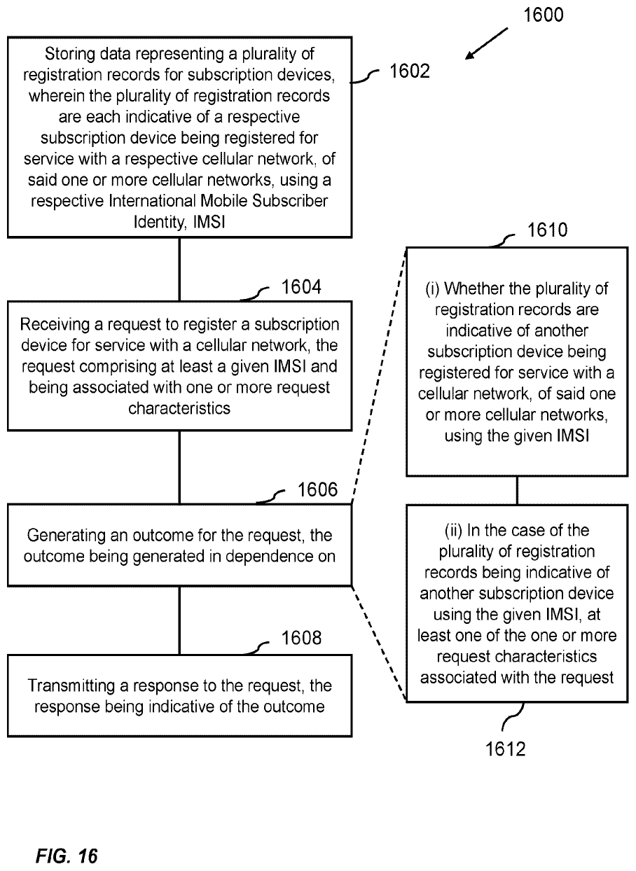

FIG. 15 shows an example of a computer system 1500, configured to implement a method 1600 for managing requests to register subscription devices for service with one or more cellular networks, shown using a flow chart in FIG. 16. The computer system 1500 comprises one or more processors 1502 and storage 1504. While components of the computer system 1500 are shown in FIG. 1500 as being included within a single computing device, it is to be appreciated that the computer system 1500 may comprise a plurality of distributed computing devices, each of the distributed computing devices including a processor(s) 1502 and storage 1500. For example, the computing system 1500 may include typical core network components such as an HLR 120, and one or more computing devices, or servers configured to communicate with these network components for the purposes of implementing the method 1600. Alternatively, the computing system may be integrated with other network components, for example, a server implementing the HLR 120 may be adapted to perform the method 1600.

The storage 1504, or storages where the computing system 1500 is a distributed computing system, store a database 1508 comprising a plurality of registration records 1508A and 1508B for subscription devices 300, 706. The plurality of registration record 1508A and 1508B are each indicative of a respective subscription device being registered for service, with a respective cellular network 104 of the one or more cellular networks, using a respective IMSI. This database 1508 may for example, be implemented as part of an HLR 120, where the HLR 120 includes the database 1508. Alternatively, this database 1508 may be a copy of a database 1508 included in an HLR 120 of the core network 118. While a Home Location Register is described, herein, it is to be appreciate that other types of home server, or register, for storing registration records 1508A and 1508B may be used. For example, a Home Subscriber Server (HSS), an authentication centre (AuC), and so forth.

The storage 1504 stores 1602 a set of computer-executable instructions 1510 which when executed by the at least one processor 1502 cause the computer system 1500 to perform the method 1600. The computer system 1500 may additionally comprise one or more communications modules 1512 that enable the computer system 1500 to communicate with subscription devices, servers, and/or network elements within or outside of the core network 118.

The method 1600 involves receiving 1604 a request 1404, shown in FIG. 14, to register a subscription device 300 for service with a cellular network 104. The request 1404 includes at least a given IMSI and is associated with one or more request characteristics. The request 1404 may, for example, be an authentication request received from the VLR 114 and includes the selected IMSI and associated authentication data.

An outcome for the request is generated 1606 and a response to the request 1404 is transmitted 1608, the response being indicative of the outcome. The outcome of the request 1404 may be either to accept the registration request 1404, which is to say authenticate the subscription device 300 based on the given IMSI in the request 1404, or to deny, or reject, the registration request 1404, which is to say not authenticate the subscription device 300 based on the given IMSI.

The outcome may be generated in dependence on criteria including whether 1610 the plurality of registration records 1508A and 1508B are indicative of another subscription device 706 being registered for service with a cellular network 104, of the one or more cellular networks, using the given IMSI. In the case that the plurality of registration records 1508A and 1508B are indicative of another subscription device 706 using the given IMSI, the outcome may be based on at least one of the one or more request characteristics associated with the request. Which is to say that the computer system 1500 may determine whether the IMSI in the request is already in use. If the IMSI is not in use by another subscription device 706, then the registration request may be handled as normal, which is to say a standards-based procedure for GSMA authentication may be performed.

While the other subscription device 706 is shown in FIGS. 1 and 7 as being in communication with the same cellular network 104 as the subscription device 300, it is to be appreciated that the subscription device 706 may be attached, or requesting to attach to, a different cellular network than that shown. For example, a further visited cellular network either in the same country or a different country to the cellular network 104.

If the given IMSI in the request is in use by another subscription device 706 then the determination of whether to accept or deny the registration request may be dependent on one or more characteristics associated with the request.

One or more of the request characteristics may be intrinsic to the request, which is to say that they are indicated in, or derivable directly from, the request 1404. Other request characteristics may be extrinsic to the request, which is to say that they may not be included in the request but may be derivable from the information in the request and in some cases with reference to external information, such as the plurality of records 1508A and 1508B, or another set of information.

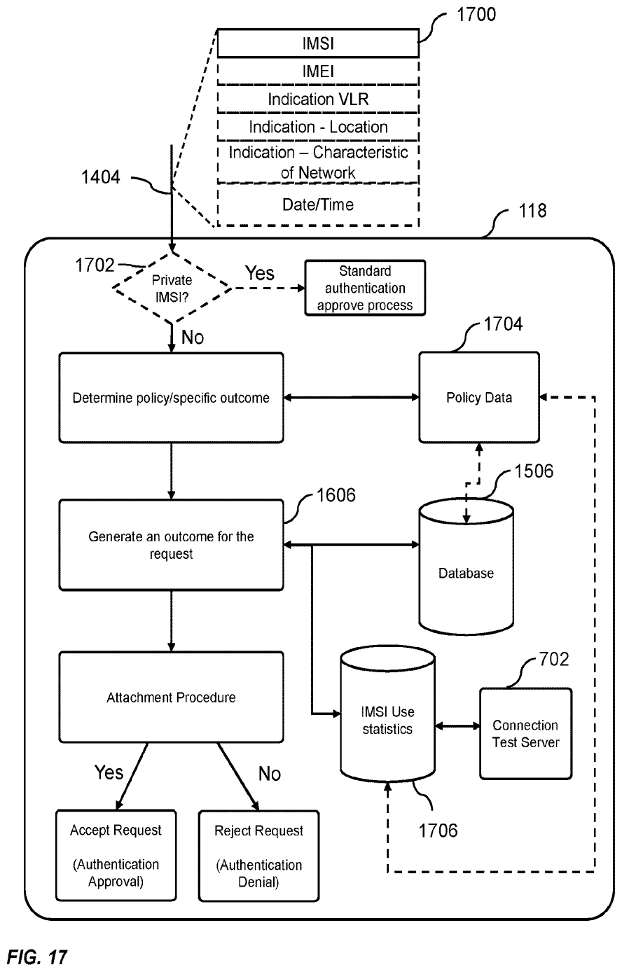

FIG. 17 shows a schematically an example of the computer-implemented method 1600 for managing registration requests. The request 1404, including the given IMSI 1700, is received into the core network 118. In some cases, an initial check 1702 is made to determine whether the IMSI 1702 is a shared or private IMSI. Private IMSI are not configured for re-use, or concurrently provided to multiple subscription devices 300. Hence if the IMSI 1702 in the request 1404 is a private IMSI, it is known that another subscription device 706 is not currently registered with the same IMSI 1702 and hence, a standard authentication approval process may be followed, as specified by GSMA, and the request may be accepted.

If the IMSI 1702 is a shared IMSI then a decision of whether to accept the request is made based on whether the IMSI 1702 is currently used to register a device for service, and based on one or more request characteristics. It is to be appreciated, that one or more of the request characteristics may be determined before it is determined whether the plurality of records 1508A and 1508B are indicative of another subscription device 706 being registered for service with a cellular network using the given IMSI.

One or more of the request characteristics may include a characteristic of the given IMSI 1700 used in the request. The decision of whether to accept or deny a given request may be, at least in part, dependent on the IMSI 1700 used in the request. The characteristic of the given IMSI 1700 may include whether the IMSI 1700 is one of a set of IMSIs that are associated with a specific outcome for the case that the plurality of subscription records 1508A and 1508B are indicative of the other subscription device 706 being registered for service with a cellular network, using the given IMSI 1700. The specific outcome in this case may be to accept or deny the request 1404. To this end, the method 1600 may compare the given IMSI 1700 with policy data 1704, which may represent a set of rules to be applied to requests 1404 to determine an outcome.

The policy data 1704 may associate IMSIs with specific outcomes and/or one or more rules, or policies, from which the outcome can be determined. The policy data 1704 may indicate whether registration requests, using particular IMSIs, should be handled according to standard GSMA authentication procedures, which in the case of the IMSI already being used for a registration would include rejecting the request. Alternatively, or additionally, the policy data 1704 may indicate whether the requests including particular IMSIs should be accepted in the case that a registration record is indicative of another subscription device being registered for service with that particular IMSI. The policy data 1704 may also specify a policy or rule to be applied to registration requests 1404 that include certain IMSIs in the case that another subscription device is registered for service using said IMSI. The rules may include processing other requests characteristics of the request 1404 to determine the outcome. The policy data 1704 may include lists of IMSIs associated with descriptors, flags, labels, or any other suitable method for indicating how requests comprising said IMSIs should be handled.

In some cases, different sets of IMSIs may be assigned to different device types, or devices having different use cases. Where a set of IMSIs is assigned to SIM profiles in IoT devices, such as smart appliances, the specific outcome, specified in the policy data 1702, may be to reject the request. Smart appliances may generally only use cellular network services sporadically and/or for limited periods of time. As such, rejecting the request may not lead to a noticeable degradation in service from the perspective of a user of the device 300, in particular, as IoT devices such as smart appliances may request to attach to networks while they are not being actively used by a user. Other sets of IMSIs may be assigned to handheld mobile devices. In this case, it may be more noticeable to a user that their mobile device is delayed in obtaining service with a cellular network and so a specific outcome may be to accept registration requests from subscription devices using IMSIs associated with, or assigned to, handheld mobile devices.

In other cases, the characteristic of the given IMSI used in the request may determine whether one or more further characteristics of the request can be used to determine whether to accept or reject the request. As described above, this may be the case where the policy data 1704 specifies that a policy should be applied to registration requests including the given IMSI 1700.

The plurality of registration records 1508A and 1508B may each be indicative of a respective subscription device being associated with respective one or more request characteristics. For example, indications of the request characteristics for each request from a subscription device may be stored in the storage 104 when the devices are registered for service and an association to these request characteristics may be included in the respective records 1508A and 1508B. Where the plurality of registration records 1508A and 1508B are indicative of another subscription device 706 using the given IMSI 1700, generating the outcome for the request 1404 may comprise processing the one or more request characteristics associated with the request 1404 and respective one or more request characteristics associated with the other subscription device 706.

For example, request characteristics may include a date and/or time of the request 1404. In this case, processing the request characteristics may include determining how long ago the other subscription device 706 requested to register for service with a cellular network. If the other subscription device 706 was registered far enough in the past, then the outcome may be to accept the new request 1404 from the subscription device 300, as the likelihood that the other subscription device 706 is currently using their service with a cellular network may be diminished. If the other subscription device 706 registered very recently, then the request 1404 may be rejected. A threshold period for which this determination is may be defined in, or generated based on, the policy data 1704 for the given IMSI 1700. For example, the policy data 1704 may specify different thresholds for different sets of IMSIs, or different device types.

Other examples of request characteristics that may be used include an indication of the VLR 114 from which the request is received, an indication of the geographic location of the subscription device 300 that is requesting to register for service with the cellular network 104, an international mobile equipment identifier (IMEI) associated with the device 300, or an indication of a characteristic of the cellular network 104 with which the subscription device 300 is requesting to register. A characteristic of the cellular network 104 may include a network type or generation (e.g. 3G, 4G, or 5G) and/or a characteristic of the network elements such as whether the VLR is configured to signal authentication requests into the core network 118. These characteristics may be considered to be intrinsic characteristics of the request 1404. For example, these characteristics may be specified explicitly in the request, or may be derivable from the manner in which the request 1404 is signalled into the core network 118, such as in data included in headers of, or packets containing, the request 1404, or from the routing of the request 1404.

In some examples, the one or more request characteristics associated with the request 1404 from the subscription device 300 may be compared with the request characteristics associated with the other device 706 to identify one or more differences. The outcome to the request 1404 may then be generated in dependence on the identified one or more differences. By comparing the request characteristics of the current request 1404 with request characteristics associated with the other subscription device 706 the method 1600 may enable the determination of the outcome to be sensitive to a likelihood of whether the two subscription devices 300 and 706 are the same device. For example, if the subscription device 300 and the other subscription device 706 are both associated with the same IMEI, then they are highly likely to be the same device and accepting the request 1404 is unlikely to lead to another device losing service. The respective locations, VLRs, network characteristics, may in combination or alone, represent a likelihood that the subscription device 300 and 706 are the same device and so can be used to determine whether the request 1404 should be accepted.

The policy data 1704 may represent a set of rules for the request including the given IMSI 1700 that determine the weighting to be applied to each of the request characteristics when determining whether to accept the request. For example, the policy data 1704 may specify that the comparison of the IMEI should be weighted more than a comparison of the geographic location. In some cases, some of these request characteristics may not be available in the comparison and in that case would have zero weighting.

In the above example, generating 1606 the outcome for the request is based on a likelihood that the two subscription devices 300 and 706 are the same device, which can be determined from the respective request characteristics. However, in other examples, the outcome may be generated 1606 based on a likelihood that two devices registered for service using the same IMSI will cause a collision. For example, if the two subscription devices are in different geographic locations, in communication with different VLRs, located in different network types (e.g. one in a 3G network and the other in 4G network), and if one of the VLRs is not configured to signal authentication requests into the core network 118 if it has cached authentication vectors, then it may be possible to accept the request 1404 without the other subscription device 1704 losing service. For example, if the device 300 and the other device 706 are both stationary appliances with cellular capabilities, then the likelihood that they will move networks or move to the same network may be small. If their respective VLRs are also not configured to signal the carrier core network 118 when they have the same caches authentication vectors then the likelihood of a collision is diminished.

If the outcome of the request includes accepting the request 1404, then the method 1600 may comprise storing a new registration record, in the database 1506, indicative of the registering subscription device 300 being registered for service with the cellular network using the given IMSI 1700.

The new registration record may be associated with the one or more request characteristics of the request 1404 when stored in the database 1506. This may include storing the request characteristics in the database 1506, storing some of the request characteristics in the database 1506, or storing some indication from which the request characteristics can be determined or looked up in the database 1506. If the subscription device 300 and the other subscription device 706 are different subscription devices then the one or more request characteristics associated with the new registration record may be indicative of the subscription device 300 being different to the other subscription device 706.

Where two devices cannot be registered for service with the same IMSI, the method 1600 may involve modifying the plurality of registration records 1508A and 1508B to remove indication that the other subscription device 706 is registered for service with a cellular network 706 using the given IMSI 1700. In some cases, the method 1600 comprises transmitting a message to the other subscription device 706, the message being indicative of the other subscription device 706 having been de-registered.

Generating 1606 the outcome for the request 1404 may also be based on IMSI use statistics 1706. For example, IMSI use statistics 1706 may be obtained from the connection test server 702 based on the registration request tracking data 902 from one or more devices. These IMSI use statistics 1706 may include indications of the frequency at which IMSIs are selected, a failure or success rate for attach requests including certain IMSIs, and/or a frequency of service loss for subscription devices 300. Generating 1606 the outcome may include modifying an outcome of the comparison between the request characteristics based on the IMSI use statistics 1706. Where a given IMSI 1700 is used very frequently in registration request procedures, the accepting outcome for the request 1404 may be de-prioritised in an attempt to reduce the frequency with which subscription devices using the given ISMI 1700 lose service. Conversely if the given IMSI is rarely used in registration request procedures 500 then the reject request outcome may be de-prioritised.

The IMSI use statistics 1706 may be temporally dependent such that they change over time and may influence the generating 1606 the outcome in different ways at different times. In this way, the core network 118 and the decision of whether to accept or reject requests 1404 may be dynamic and can change over time based on a condition in the cellular networks 114. This enables the method 1600 to tune the service provided to multiple subscription devices 300 and 706 and thereby manage trade-offs and balance performance of the networks. The method 1600 may thereby mitigate the frequency at which a subscription device 706 loses service when another device 300 attempts to register for service with the same IMSI, while simultaneously increasing the average speed with which devices 300 can register for service. The IMSI use statistics 1706 may be considered when generating the outcome request 1606 but may alternatively, or additionally, be used to directly modify the policy data 1704, for example by modifying weightings associated with different request characteristics, defining specific outcomes for some IMSIs based on their usage in the networks, and so forth.

The policy data 1704 may also define clean up rules, or policies, for the database 1506. For example, the policy data 1704 may specify rates at which registration records 1508A and 1508B should be scrubbed, or removed, from the database 1506. In some cases, registration records 1508A and 1508B may be removed from the database 1506 after a predetermined period of time. This may cause a device 706 using said IMSI to re-register for service, but also frees up the IMSI for use by another device 300. Different predetermined periods of time may be defined for different IMSIs, and these periods of time may be modifiable, for example, based on the IMSI use statistics 1706.

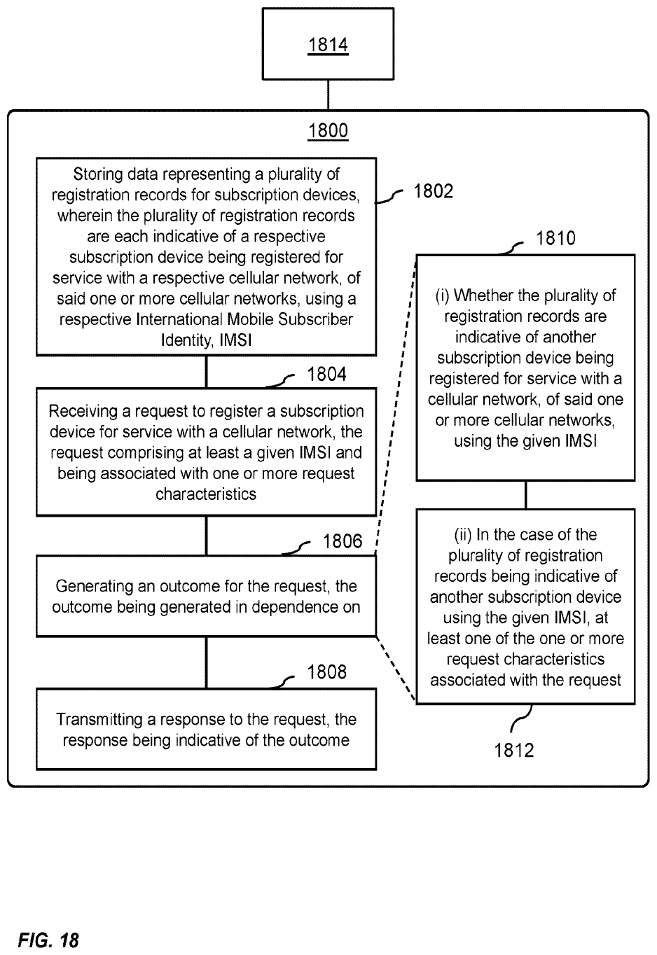

FIG. 18 shows a non-transitory computer-readable storage medium 1800 including a set of computer-executable instructions 1802 to 1812 which, when executed by a processor 1814 cause the processor to perform a method 1600 for managing requests to register subscription devices for service with one or more cellular networks as described with respect to FIGS. 14 to 17. The various examples, and modifications to the method 1600 described above may also apply to the instructions 1802 to 1812 when executed by the processor 1814. The storage medium 1800 in this case may include multiple individual storage mediums for example communicatively coupled with, or included in, different computing devices in the core network 118 that are configured to perform the method 1600.

The above embodiments are to be understood as illustrative examples of the presently disclosed subject matter. Further embodiments of the presently disclosed subject matter are envisaged. For example, while the subscription devices 300 and 706 have been shown as being in visited networks 104, they may be located in the carrier core network 118. In this case, certain request characteristics may not be available or relevant. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the presently disclosed subject matter, which is defined in the accompanying claims.

1. A computer-implemented method for requesting to register a subscription device for service with one or more cellular network, the computer-implemented method comprising:
providing a profile comprising a plurality International Mobile Subscriber Identities, IMSIs, for registering the subscription device for service with one or more cellular network;
performing a first registration request procedure to request to register the subscription device for service with a cellular network, the first registration request procedure comprising:
selecting a first IMSI from the plurality of IMSIs; and
performing an attach request procedure to attach to the cellular network using the first IMSI,
performing a connection test procedure, the connection test procedure comprising: transmitting a connection test message to a test server; and
performing a second registration request procedure to request to register the subscription device for service with a cellular network, the second registration request process comprising:
selecting a second IMSI from the plurality of IMSIs; and
performing an attach request procedure to attach to the cellular network using the second IMSI,
wherein performing the second registration request procedure is triggered in dependence on receipt of a response to the connection test message.

2. The computer-implemented method of claim 1, wherein the connection test message comprises registration request tracking data.

3. The computer-implemented method of claim 1, wherein the first registration request procedure and the connection test procedure are performed substantially concurrently.

4. The computer-implemented method of claim 1, wherein the connection test procedure is performed repeatedly.

5. The computer-implemented method of claim 4, wherein the connection test procedure is performed periodically with a predetermined interval between performances of the connection test procedure.

6. The computer-implemented method of claim 3, wherein the predetermined interval is dependent on a device type corresponding to the subscription device.

7. The computer-implemented method of claim 1, wherein the method comprises: determining one or more characteristics associated with the subscription device; and modifying the predetermined interval in dependence on the one or more characteristics.

8. The computer-implemented method of claim 1, wherein the connection test procedure is triggered by the subscription device detecting a need for service with a cellular network when the subscription device has a service status that does not satisfy the need.

9. The computer-implemented method of claim 2, wherein the registration request tracking data relating to the first registration request procedure comprises an indication of any one or more of:
a number of failed attach request procedures having occurred in the first registration request procedure;
a number of failed attach request procedures having occurred since a previous reset of the profile;
a number of IMSIs having been selected since the previous reset of the profile; IMSIs having been selected since the previous reset of the profile; and
a region-specific date and time of the connection test procedure, relating to a region in which the subscription device is located.

10. The computer-implemented method of claim 1, wherein the test server is a server operating a Transfer Client Protocol echo client.

11. A subscription device comprising at least one processor and at least one memory, the at least one memory comprising computer-executable instructions which, when executed by the at least one processor, cause the processor to perform a computer-implemented method according to any preceding claim.

12. The subscription device according to claim 11, wherein the subscription device comprises a secure module, and wherein the computer-implemented method is performed by the secure module.

13. A non-transitory computer-readable storage medium comprising computer executable instructions which, when executed by a processor, cause the processor to perform a computer-implemented method according to claim 1.

14. A computer-implemented method for operating a connection test server, the computer implemented method comprising: obtaining a test message from a subscription device according to claim 11, the message including an indication of the subscription device; and responding to the test message to confirm receipt of the test message.

15. A computer-implemented method according to claim 14 wherein the method comprises: processing the test message to identify registration request tracking data relating to a registration request procedure; and storing the identified registration request tracking data.

16. A computer-implemented method according to claim 14, wherein responding to the test message includes responding to the test message before a predetermined time period has elapsed since obtaining the test message.

17. A computer-implemented method according to claim 16, wherein the predetermined time period is selectable.

18. A connection test server comprising:
at least one processor; and
at least one memory, the at least one memory comprising computer-executable instructions which, when executed by the at least one processor, cause the at least one processor to perform a method according to claim 14.

19. The computer-implemented method of claim 14, wherein the connection test server implements a Transfer Client Protocol echo client.
